(19) United States
(12) Patent Application Publication
(10) Pub. No.: US 2024/0045170 A1
(43) Pub. Date: Feb. 8, 2024

(54) OPTICAL ELEMENT DRIVING DEVICE, CAMERA MODULE, AND CAMERA-MOUNTED DEVICE

(71) Applicants: Tomohiko OSAKA, Tokyo (JP); Shun SUZUKI, Tokyo (JP)

(72) Inventors: Tomohiko OSAKA, Tokyo (JP); Shun SUZUKI, Tokyo (JP)

(73) Assignee: Mitsumi Electric Co., Ltd., Tokyo (JP)

(21) Appl. No.: 18/229,750

(22) Filed: Aug. 3, 2023

(30) Foreign Application Priority Data
Aug. 5, 2022 (JP) 2022-125639

(51) Int. Cl. G02B 7/09; G02B 13/00; G03B 5/00

(52) U.S. Cl. CPC G02B 7/09; G02B 13/009; G03B 5/00; G03B 2205/0069

(57) ABSTRACT

An optical element driving device configured to drive an optical element, the optical element driving device including: a holding part configured to hold an optical element; a housing part configured to house inside the holding part; and a supporting part interposed between an outer peripheral surface of the holding part and an inner peripheral surface of the housing part, and including a plurality of rolling members configured to be held by a retainer in a rollable manner, the supporting part being configured to support the holding part with the plurality of rolling members such that the holding part is movable with respect to the housing part. At least one of the outer peripheral surface and the inner peripheral surface includes a first recess formed at a portion facing the retainer.

### CROSS REFERENCE TO RELATED APPLICATIONS

This application claims the benefit of priority of Japanese Patent Application No. 2022-125639, filed on Aug. 5, 2022, the contents of which are incorporated by reference as if fully set forth herein in their entirety.

### TECHNICAL FIELD

The present invention relates to an optical element driving device that drives optical elements, a camera module and a camera-mounted device.

### BACKGROUND ART

In general, a camera module is mounted in a camera-mounted device such as a smartphone and a drone. In such a camera module, an optical element driving device that drives optical elements is used. Note that a drone is an unmanned aircraft that can be flown by remote control or automatic control, and is also called a multicopter.

An optical element driving device has an auto focus function (hereinafter referred to as “AF function”, AF: Auto Focus). With the AF function, the optical element driving device automatically performs focusing for capturing the subject by moving the lens in the optical axis direction.

For example, PTL 1 discloses a lens driving device including a lens holding part that holds a lens, an intermediate moving body that guides the lens holding part along the guide member in the optical axis direction, and a driving part that moves the lens holding part along the guide member in the optical axis direction. The intermediate moving body includes a plurality of balls guided by the guide groove of the guide member, and a retainer that holds the balls in a rollable manner.

### CITATION LIST

### Patent Literature

PTL 1
Japanese Patent Application Laid-Open No. 2001-141977

### SUMMARY OF INVENTION

### Technical Problem

As disclosed in PTL 1, in the lens driving device, the ball and the retainer are used to guide the lens holding part in the optical axis direction. In such a configuration, grease is applied to the ball for lubricity between the ball and the retainer. For example, even when the position of the ball held by the retainer is displaced from the reference position due to external impact such as dropping, the ball is rollable with the applied grease.

In this manner, the grease applied to the ball contributes to the lubricity between the ball and the retainer. However, for example, the grease may possibly scatter to the surroundings due to the external impact such as dropping, and if the scattered grease enters the gap between the retainer and the surrounding member, the retainer may possibly stick to the member. The retainer moves in the optical axis direction together with the ball, and if the sticking of the retainer occurs, the resistance of the movement of the lens holding part may possibly be generated.

An object of the present invention is to provide an optical element driving device, a camera module and a camera-mounted device that can prevent the generation of the resistance to the movement of the optical element.

### Solution to Problem

To achieve the above-mentioned object, an optical element driving device according to the present invention is configured to drive an optical element, the optical element driving device including: a holding part configured to hold an optical element; a housing part configured to house inside the holding part; and a supporting part interposed between an outer peripheral surface of the holding part and an inner peripheral surface of the housing part, and including a plurality of rolling members configured to be held by a retainer in a rollable manner, the supporting part being configured to support the holding part with the plurality of rolling members such that the holding part is movable with respect to the housing part. At least one of the outer peripheral surface and the inner peripheral surface includes a first recess formed at a portion facing the retainer.

To achieve the above-mentioned object, a camera module according to the present invention includes: the optical element driving device; a driving part configured to drive the holding part; and an image capturing part configured to capture a subject image by using the optical element.

To achieve the above-mentioned object, a camera-mounted device according to the present invention is an information device or a transport device, the camera-mounted device including: the camera module; and an image processing part configured to process image information obtained by the camera module.

### Advantageous Effects of Invention

According to the present invention, the generation of the resistance to the movement of the optical element can be prevented.

### BRIEF DESCRIPTION OF DRAWINGS

FIG. 1A is a front view illustrating a smartphone equipped with a camera module according to an embodiment of the present invention;

FIG. 1B is a rear view of the smartphone illustrated in FIG. 1A;

FIG. 2 is a perspective view illustrating a camera module and an image-capturing part;

FIG. 3 is a plan view of an optical element driving device body provided in an optical element driving device of the camera module;

FIG. 4 is an enlarged view illustrating a supporting part of the optical element driving device body illustrated in FIG. 3;

FIG. 5 is an exploded perspective view of a part of a supporting part of the optical element driving device body illustrated in FIG. 3 in an exploded manner;

FIG. 6 is a side view illustrating an outer peripheral surface of a holding part of the optical element driving device body illustrated in FIG. 3, and is a diagram illustrating a region around the supporting part;

FIG. 7 is a side view illustrating an inner peripheral surface of a housing part of the optical element driving device body illustrated in FIG. 3, and is a diagram illustrating a region around the supporting part;

FIG. 8 is a plan view illustrating a substrate part of the optical element driving device body illustrated in FIG. 3, and is a planar development diagram of the substrate part;

FIG. 9 is a diagram illustrating the optical element driving device body illustrated in FIG. 3 as viewed from outside;

FIG. 10 is a diagram illustrating a housing part of the optical element driving device body illustrated in FIG. 3 as viewed from the inside;

FIG. 11A is a front view illustrating an automobile as a camera-mounted device equipped with an in-vehicle camera module; and

FIG. 11B is a perspective view of the automobile illustrated in FIG. 11A as viewed from an oblique rearward side.

### DESCRIPTION OF EMBODIMENTS

An embodiment of the present invention is elaborated below with reference to the accompanying drawings.

### Smartphone

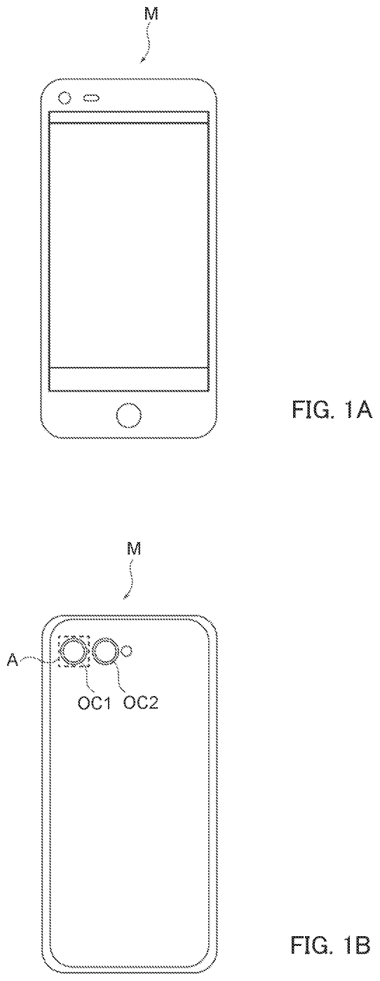

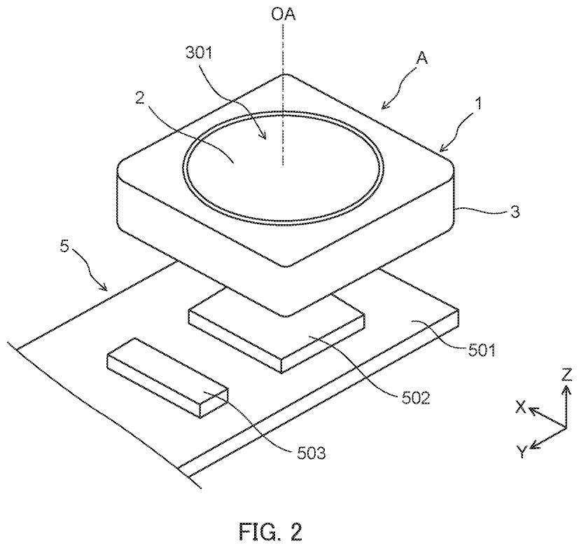

FIGS. 1A and 1B illustrate smartphone M (an example of the camera-mounted device) equipped with camera module A according to the present embodiment. FIG. 1A is a front view of smartphone M, and FIG. 1B is a rear view of smartphone M.

Smartphone M includes a dual camera comprising two back surface cameras OC1 and OC2. In the present embodiment, camera module A is applied to back surface cameras and OC2.

Camera module A has an AF function, and can automatically perform focusing when capturing the subject. Note that camera module A may include a shake correction function (hereinafter referred to as “OIS function”, OIS: Optical Image Stabilization). With the OIS function, images with no image blurring can be captured by optically correcting the runout (vibration) that is caused upon capturing an image.

### Camera Module

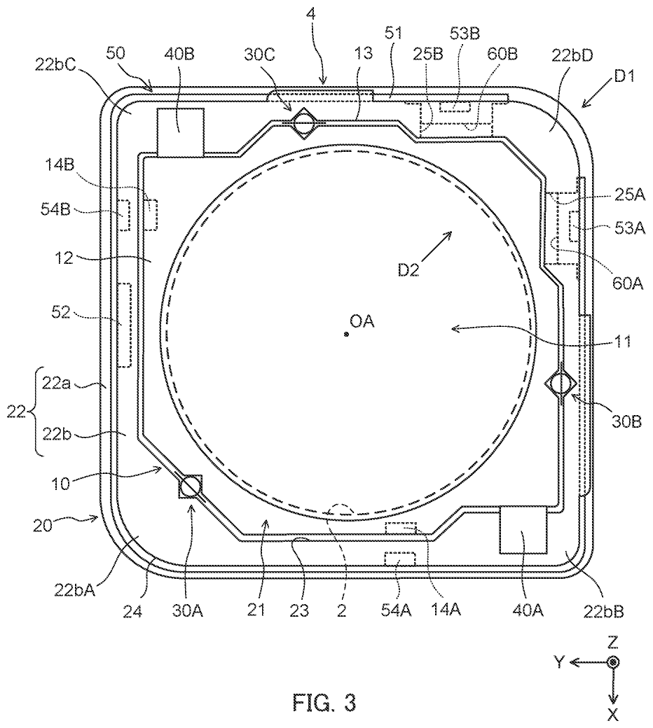

FIG. 2 is a perspective view illustrating camera module A and image-capturing part FIG. 3 is a plan view of optical element driving device body 4 provided in optical element driving device 1 of camera module A illustrated in FIG. 2. As illustrated in FIGS. 2 and 3, the present embodiment is described using the orthogonal coordinate system (X, Y, Z). In addition, the drawings described later are also described using the orthogonal coordinate system (X, Y, Z).

Camera module A is mounted such that when an image is captured with smartphone M, the X direction is the up-down direction (or left-right direction), the Y direction is the left-right direction (or up-down direction), and the Z direction is the front-rear direction, for example. Specifically, the Z direction is the optical axis direction of optical axis OA of lens part 2 illustrated in FIG. 2, the upper side (+Z side) in FIG. 2 is the light reception side of the optical axis direction and the lower side (−Z side) in FIG. 2 is the imaging side of the optical axis direction.

Note that in the following description, while the description will be made using optical axis OA, the optical axis direction of optical axis OA may be referred to as optical path direction, or focusing direction (direction of adjusting the focal point) in accordance with the type of the optical element. Here, the optical path is the optical route formed by opening 301 of cover 3 described later, opening 11 of holding part 10 described later, or housing opening 21 of housing part 20 described later, and the extending direction of the optical path (the extending direction of each opening) is the optical path direction.

As illustrated in FIGS. 2 and 3, camera module A includes optical element driving device 1 that achieves the AF function, lens part 2 with a lens housed in a cylindrical lens barrel, image-capturing part 5 that captures a subject image formed by lens part 2, and the like. Specifically, optical element driving device 1 is a so-called lens driving device that drives lens part 2 as an optical element.

### Cover

In optical element driving device 1, the outside of optical element driving device body 4 is covered with cover 3. Cover 3 is a capped quadrangular cylindrical member with a substantially rectangular shape in plan view as viewed from the Z direction. In the present embodiment, cover 3 has a substantially square shape in plan view. Cover 3 includes substantially semicircular opening 301 in a top surface. Lens part 2 is configured to be housed in opening 11 of holding part 10 of optical element driving device body 4, so as to face outside from opening 301 of cover 3 and protrude to the light reception side than the opening surface of cover 3 along with the movement in the Z direction. The inner wall of cover 3 is fixed by bonding to housing part 20 (bottom part 22a) of optical element driving device body 4, and houses optical element driving device body 4, for example.

Cover 3 includes a member, such as a shielding member comprising a magnetic substance, that blocks the electromagnetic waves from the outside of optical element driving device 1 and/or the inside of cover 3.

### Image-Capturing Part

Image-capturing part 5 is disposed on the imaging side of optical element driving device 1. Image-capturing part 5 includes image sensor substrate 501, and imaging element 502 and control part 503 mounted on image sensor substrate 501, for example. Imaging element 502 comprises a CCD (charge-coupled device) image sensor, a CMOS (complementary metal oxide semiconductor) image sensor or the like, and captures a subject image formed by lens part 2, for example.

Control part 503 comprises a control IC, and drives and controls optical element driving device 1, for example. Optical element driving device 1 is mounted to image sensor substrate 501 and mechanically and electrically connected. Control part 503 may be provided in image sensor substrate 501, or in a camera-mounted device equipped with camera module A (in the present embodiment, smartphone M).

Note that in FIG. 2, the subject image is formed on imaging element 502 by driving lens part 2 in the Z direction by optical element driving device 1 with respect to image sensor substrate 501 whose position is fixed, but imaging element 502 may be driven in the Z direction, for example. In this case, it suffices to form a subject image on imaging element 502 by driving imaging element 502, which is an optical element, in the Z direction by optical element driving device 1 with lens part 2 fixed to cover 3.

### Optical Element Driving Device Body

Optical element driving device body 4 is a body portion of optical element driving device 1 that drives lens part 2, which is an optical element, in the Z direction. Note that the following description assumes that optical element driving device 1 drives lens part 2 for convenience of description, but optical element driving device 1 may drive imaging element 502 as described above.

As illustrated in FIG. 3, optical element driving device body 4 includes holding part housing part 20, supporting parts 30A, 30B and 30C, driving parts 40A and 40B, substrate part 50 and the like.

### Holding Part

Holding part 10 includes frame part 12 with opening 11 formed at a center portion, and opening 11 is configured to be able to hold lens part 2 inside. For example, opening 11 is configured with an attaching groove or the like formed at its inner peripheral surface so as to be able to hold lens part 2 at the inner peripheral surface. In this manner, holding part holds lens part 2 by surrounding the outer periphery of lens part 2.

A plurality of portions (e.g., three portions in FIG. 3) in outer peripheral surface 13, which is the outer periphery side of frame part 12, is supported in a movable manner in the Z direction with supporting parts 30A, 30B and 30C extending along the Z direction.

In addition, a plurality of portions (e.g., two portions in FIG. 3) in outer peripheral surface 13 is held by driving parts 40A and 40B, and holding part 10 is movable in the Z direction by driving parts 40A and 40B.

In addition, outer peripheral surface 13 is provided with magnets 14A and 14B for detecting the Z direction position at a plurality of portions (e.g., two portions in FIG. 3) thereof. Position detection sensors 54A and 54B described later are provided so as to face magnets 14A and 14B.

Note that opening 11 is formed in a cylindrical shape to match the cylindrical shape of lens part 2, but its shape may be changed to an appropriate shape in accordance with the shape of lens part 2.

In addition, in the case where optical element driving device 1 drives imaging element 502, holding part 10 may not be provided with opening 11, that is, holding part 10 may not be a frame part. In this case, for example, it suffices to hold imaging element 502 at the top surface (light reception side surface) of holding part 10.

### Housing Part

Housing part 20 includes frame part 22 provided with housing opening 21 formed at a center portion, and housing opening 21 is configured to be able to house holding part 10 inside so as to surround the outer periphery of holding part 10.

Supporting parts 30A, 30B and 30C are provided at a plurality of portions in inner peripheral surface 23 inside housing opening 21. Housing part 20 supports holding part 10 in a movable manner in the Z direction with supporting parts 30A, 30B and 30C.

In addition, driving parts 40A and 40B are provided at a plurality of portions in inner peripheral surface 23. Driving parts 40A and 40B provided in housing part 20 move holding part 10 in the Z direction. Holding part 10 functions as a movable part driven by driving parts 40A and 40B, and housing part 20 functions as a fixed part with respect to holding part 10.

In plan view, inner peripheral surface 23 is formed to match the shape of outer peripheral surface 13 of holding part 10. In FIG. 3, the shapes of outer peripheral surface 13 of holding part 10 and inner peripheral surface 23 of housing opening 21 are examples, and may be appropriately changed in accordance with the arrangement of supporting parts 30B and 30C, driving parts 40A and 40B and the like, for example.

Frame part 22 includes bottom part 22a and side wall part 22b. The above-described inner wall of cover 3 is fixed by bonding to bottom part 22a, for example. Substrate part 50 is attached to and along outer peripheral surface 24, which is the outer periphery of side wall part 22b.

### Supporting Part

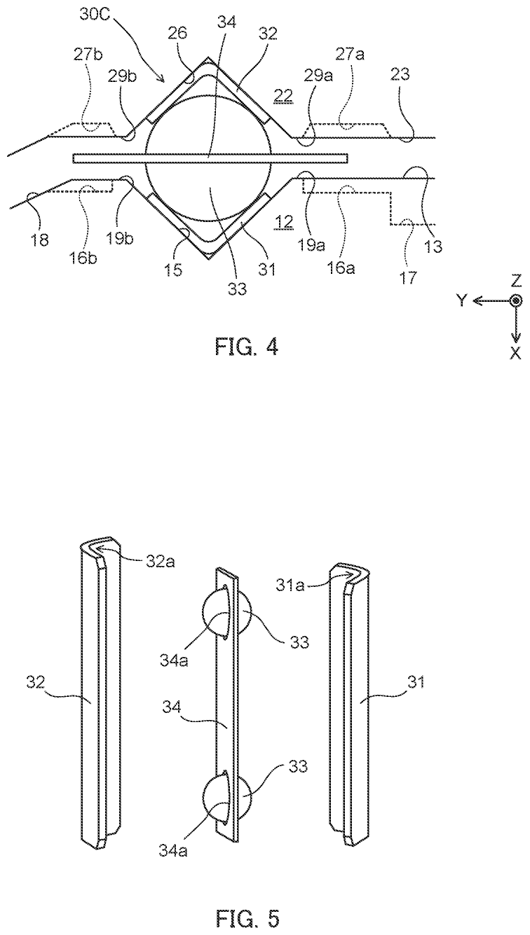

Supporting parts 30A, 30B and 30C are interposed between outer peripheral surface 13 of holding part 10 and inner peripheral surface 23 of housing part 20, and support holding part 10 in a movable manner in the Z direction with respect to housing part 20. As illustrated in FIG. 3, supporting parts 30A, 30B and 30C are disposed in inner peripheral surface 23 (outer peripheral surface 13) at a three portions separated from one another in the circumferential direction. Supporting parts 30A, 30B and 30C are described below with reference to FIGS. 4 and 5.

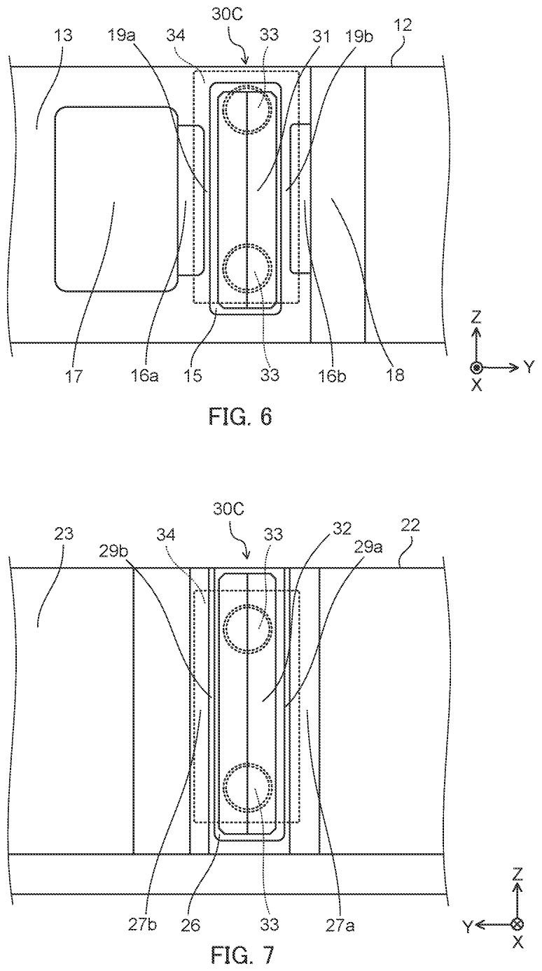

FIG. 4 is an enlarged view illustrating supporting part 30C of optical element driving device body 4 illustrated in FIG. 3. FIG. 5 is an exploded perspective view of a part of supporting part 30C of optical element driving device body 4 illustrated in FIG. 3 in an exploded manner. Note that here, as an example, description will be made for supporting part 30C illustrated in FIGS. 4 and 5. In addition, configurations (recesses 16a, 16b, 27a, 27b and the like) in a region around supporting part 30C illustrated in FIG. 4 will be described later with reference to FIGS. 6 and 7.

Supporting part 30C includes first groove part 15, second groove part 26, first rail member 31, second rail member 32, rolling member 33 (e.g., a ball member and the like), and retainer 34.

First groove part 15 is a groove formed to be recessed in a V-shape and provided to extend in the Z direction at outer peripheral surface 13 of frame part 12 of holding part 10. Second groove part 26 is a groove formed to be recessed in a V-shape and provided to extend in the Z direction at inner peripheral surface 23 of frame part 22 of housing part 20. First groove part 15 and second groove part 26 are disposed to face each other.

First rail member 31 is a V-shaped cross-sectional member extending in the longitudinal direction that is the Z direction at the time of attaching. First rail member 31 includes V-shaped guide groove 31a on the side on which rolling member 33 is disposed (in the present invention, the groove), and is attached to first groove part 15 on the side opposite to that side.

Second rail member 32 is a V-shaped cross-sectional member extending in the longitudinal direction that is the Z direction at the time of attaching. Second rail member 32 includes V-shaped guide groove 32a on the side on which rolling member 33 is disposed (in the present invention, the groove), and is attached to second groove part 26 on the side opposite to that side. First rail member 31 is attached to first groove part 15, and second rail member 32 is attached to second groove part 26, and thus, guide groove 31a and guide groove 32a thereof are disposed to face each other.

A plurality of (e.g., two in FIG. 5) rolling members 33 is housed and sandwiched in a rollable manner between guide groove 31a of first rail member 31 and guide groove 32a of second rail member 32 disposed in this manner. The plurality of rolling members 33 rolls along guide groove 31a and guide groove 32a so as to be guided in the Z direction.

Retainer 34 includes holding holes 34a corresponding to the number of rolling members 33. The plurality of rolling members 33 is held in a rollable manner by respective holding holes 34a, and disposed along the Z direction. With retainer 34, the distance between the plurality of rolling members 33 is kept constant.

Supporting part 30C has the above-described configuration, and supporting parts 30A and 30B also have the same configuration. With supporting parts 30A, 30B and 30C having the above-mentioned configurations, holding part 10 is supported in a movable manner in the Z direction with respect to housing part 20. As described above, supporting parts 30A, 30B and 30C include the plurality of rolling members 33 disposed along the Z direction, and thus can stably suppress the tilting (tilt) of holding part 10.

In addition, rolling member 33 normally comprises materials such as ceramics and alloys. With first rail member 31 and second rail member 32 comprising a metal material or the like provided at first groove part 15 and second groove part 26, first rail member 31 and second rail member 32 are less deformed even when a pressing force is received from rolling member 33. With this configuration, supporting parts 30A, 30B and 30C can stably support holding part 10 in a movable manner in the Z direction.

### Configuration of Region Around Supporting Part

FIG. 6 is a side view illustrating outer peripheral surface 13 of holding part 10 of optical element driving device body 4 illustrated in FIG. 3, and is a diagram illustrating a region around supporting part 30C. In addition, FIG. 7 is a side view illustrating inner peripheral surface 23 of housing part 20 of optical element driving device body 4 illustrated in FIG. 3, and is a diagram illustrating a region around supporting part 30C. Note that here, as an example, description will be made for supporting part 30C illustrated in FIGS. 6 and 7.

As described above, first groove part 15 is formed in outer peripheral surface 13 of frame part 12 of holding part 10, and first rail member 31 is attached to first groove part 15. In addition, second groove part 26 is formed in inner peripheral surface 23 of frame part 22 of housing part 20, and second rail member 32 is attached to second groove part 26. Retainer 34 is disposed such that rolling member 33 is sandwiched between guide groove 31a of first rail member 31 and guide groove 32a of second rail member 32.

Also in the present embodiment, for the lubricity between rolling member 33 and retainer 34 (holding hole 34a), grease is applied to rolling member 33. With the applied grease, rolling member 33 is rollable even when the position of rolling member 33 held by retainer 34 (holding hole 34a) is displaced from the reference position due to the external impact such as dropping, for example.

On the other hand, the grease applied to rolling member 33 may possibly scatter to the surroundings due to the external impact such as dropping, and if the scattered grease enters the gap between retainer 34 and the surrounding member, retainer 34 may possibly stick to the member, for example.

For example, as illustrated in FIG. 4, a gap where retainer 34 is movable in the Z direction is formed between retainer 34 and outer peripheral surface 13 and inner peripheral surface 23 facing retainer 34. At the above-described gap, if the grease enters the space formed with retainer 34, retainer 34 sticks to outer peripheral surface 13 and inner peripheral surface 23 due to the grease, which may possibly block the movement of retainer 34, and in turn, the movement of holding part 10.

In view of this, in the present embodiment, recesses 16a and 16b (in the present invention, the first recess) formed at a portion facing retainer 34 at outer peripheral surface 13 in a manner recessed from outer peripheral surface 13 are provided. In addition, recesses 27a and 27b (in the present invention, the first recess) formed at a portion facing retainer 34 in inner peripheral surface 23 in a manner recessed from inner peripheral surface 23 are provided.

With reference also to the side view illustrated in FIG. 6, recess 16a is disposed to face one end portion (in FIG. 6, the left side) of retainer 34 in the direction (in FIG. 6, the Y direction) orthogonal to the Z direction, and extended along one end portion of retainer 34 extending n the Z direction.

In addition, recess 16b is disposed to face the other end portion (in FIG. 6, the right side) of retainer 34 in the direction (in FIG. 6, the Y direction) orthogonal to the Z direction, and extended along the other end portion of retainer 34 extending in the Z direction.

In addition, with reference also to the side view illustrated in FIG. 7, recess 27a is disposed to face one end portion (in FIG. 7, the right side) of retainer 34 in the direction (in FIG. 6, the Y direction) orthogonal to the Z direction, and extended along one end portion of retainer 34 extending n the Z direction.

In addition, recess 27b is disposed to face the other end portion (in FIG. 7, the left side) of retainer 34 in the direction (in FIG. 6, the Y direction) orthogonal to the Z direction, and extended along the other end portion of retainer 34 extending in the Z direction.

Retainer 34 is rotatable around the Z axis with rolling member 33 as a rotation center in the gap between outer peripheral surface 13 and inner peripheral surface 23 (see FIG. 4).

When retainer 34 rotates around the Z axis, and one end side (the lower side in FIG. 4 and the left side in FIG. 6) of retainer 34 is close to outer peripheral surface 13, the gap between retainer 34 and outer peripheral surface 13 is small. In addition, also when the other end side (the lower side in FIG. 4 and the right side in FIG. 6) of retainer 34 is close to outer peripheral surface 13, the gap between retainer 34 and outer peripheral surface 13 is small.

In the present embodiment, by providing the above-described recesses 16a and 16b, the bottom surfaces of recesses 16a and 16b are separated from outer peripheral surface 13 with respect to the above-described one end side and other end side of retainer 34. In this manner, even when the scattered grease adheres to recesses 16a and 16b, the grease less makes contact with retainer 34.

In addition, first groove part 15 and recesses 16a and 16b are separated from each other with protrusions 19a and 19b therebetween in the direction (in FIGS. 4 and 6, the Y direction) orthogonal to the Z direction.

With protrusions 19a and 19b, the rotation of retainer 34 around the Z axis is restricted, and a predetermined gap is ensured between retainer 34 and the bottom surfaces of recesses 16a and 16b such that the grease adhered to recesses 16a and 16b less makes contact with retainer 34. In addition, with protrusions 19a and 19b, the grease is retained inside first groove part 15.

In this manner, by providing recesses 16a and 16b in outer peripheral surface 13, the sticking of retainer 34 with the grease can be prevented by making the scattered grease less make contact with retainer 34.

Note that in FIG. 6, protrusions 19a and 19b with the same width in the Y direction are extended in the Z direction, but they may not have the same width. For example, in the Z direction of protrusions 19a and 19b, the width of the center portion may be greater or smaller than that at the both ends, or the width may gradually increase or decrease toward the center portion from the both ends.

Recesses 27a and 27b have the same function as that of recesses 16a and 16b. When retainer 34 rotates around the Z axis, and the one end side (the upper side in FIG. 4 and the right side in FIG. 7) of retainer 34 is close to inner peripheral surface 23, the gap between retainer 34 and inner peripheral surface 23 is small. In addition, when the other end side (the upper side in FIG. 4 and the left side in FIG. 7) of retainer 34 is close to inner peripheral surface 23, the gap between retainer 34 and inner peripheral surface 23 is small.

In the present embodiment, by providing the above-described recesses 27a and 27b, the bottom surfaces of recesses 27a and 27b are separated from inner peripheral surface 23 with respect to the above-described one end side and other end side of retainer 34. In this manner, even when the scattered grease adheres to recesses 27a and 27b, the grease less makes contact with retainer 34.

In addition, second groove part 26 and recesses 27a and 27b are separated from each other with protrusions 29a and 29b therebetween in the direction (the Y direction in FIGS. 4 and 7) orthogonal to the Z direction.

With protrusions 29a and 29b, the rotation of retainer 34 around the Z axis is restricted, and a predetermined gap is ensured between retainer 34 and the bottom surfaces of recesses 27a and 27b such that the grease adhered to recesses 27a and 27b less makes contact with retainer 34. In addition, with protrusions 29a and 29b, the grease is retained inside second groove part 26.

In this manner, by providing recesses 27a and 27b in inner peripheral surface 23, the sticking of retainer 34 with the grease can be prevented by making the scattered grease less make contact with retainer 34.

Note that while recesses 16a and 16b are provided in outer peripheral surface 13 and recesses 27a and 27b are provided in inner peripheral surface 23 in this case, it is possible to adopt a configuration one of recesses 16a and 16b and recesses 27a and 27b is provided.

In addition, at least one of outer peripheral surface 13 and inner peripheral surface 23 may include another recess or the like formed adjacent to at least one of recesses 16a and 16b and recesses 27a and 27b on the side opposite to supporting part 30C side in the direction orthogonal to the Z direction.

As an example, with reference to FIG. 6, outer peripheral surface 13 includes recess 17 (in the present invention, the second recess) formed adjacent to recess 16a between the side opposite to supporting part 30C (first groove part 15) in the direction (in FIG. 6, the Y direction) orthogonal to the Z direction. Recess 17 has an opening area greater than that of recess 16a, and is recessed deeper than recess 16a.

With recess 17 provided adjacent to recess 16a, the grease of recess 16a is spread to recess 17 in the direction away from retainer 34 such that the grease is not retained in recess 16a, and that the sticking of retainer 34 with the grease can be prevented.

Note that the configuration provided adjacent to recesses 16a and 16b and recesses 27a and 27b is not limited to recesses like recess 17 as long as the grease can be spread in the direction away from retainer 34. For example, as illustrated in FIG. 4, it is possible to adopt a configuration in which inclined part 18 is provided adjacent to recess 16b and the grease of recess 16b is spread to inclined part 18 in the direction away from retainer 34.

### Driving Part

Driving parts 40A and 40B drive holding part 10 in the Z direction with respect to housing part 20. As illustrated in FIG. 3, driving parts 40A and 40B are disposed at two portions separated from each other in the circumferential direction at inner peripheral surface 23 (outer peripheral surface 13). With the above-described supporting parts 30A, 30B and and driving parts 40A and 40B, optical element driving device body 4 can drive lens part 2 in the Z direction together with holding part 10, thus achieving the AF function.

In the example illustrated in FIG. 3, driving parts 40A and 40B are disposed at corner portions 22bB and 22bC that are point symmetrical about optical axis OA in plan view, which are corner portions different from corner portion 22bA where supporting part is disposed. With this arrangement, holding part 10 can be stably moved even in the case where the weight of the optical elements such as lens part 2 increases.

As driving parts 40A and 40B, an actuator including a piezoelectric element, such as an ultrasound motor, is used. Note that a driving source such as a voice coil motor (VCM) may be used.

### Substrate Part

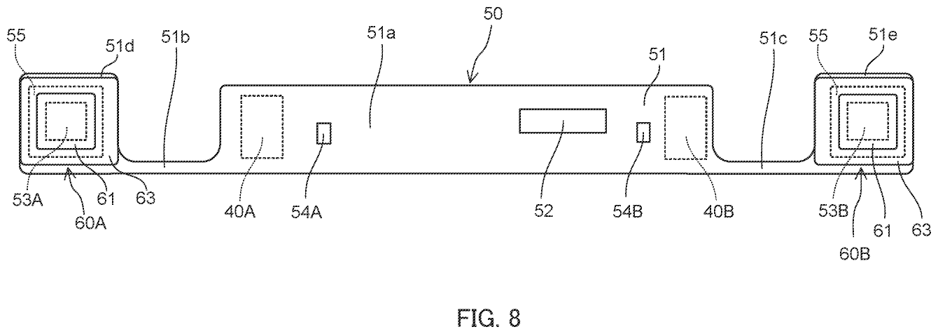

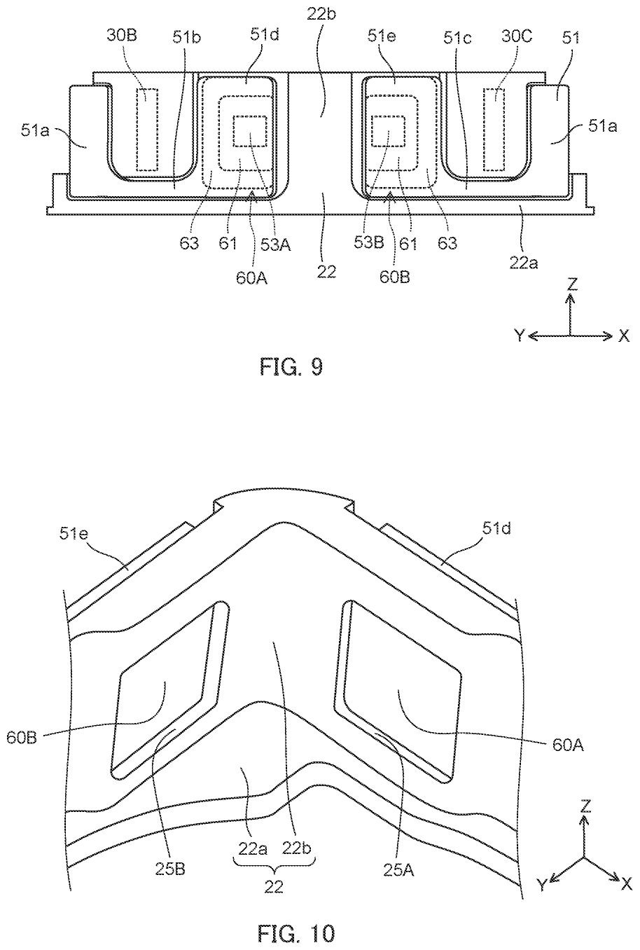

Substrate part 50 is described below with reference to FIGS. 8 and 9, together with FIG. 3. FIG. 8 is a plan view illustrating substrate part 50 of optical element driving device body 4 illustrated in FIG. 3, and is a planar development diagram of substrate part 50. FIG. 9 is a diagram illustrating optical element driving device body 4 illustrated in FIG. 3 as viewed from outside, and is a diagram as viewed from direction D1 illustrated in FIG. 3. Note that driving parts 40A and 40B are not mounted on FPC 51 of substrate part 50, but FIG. 8 illustrates driving parts 40A and 40B for the sake of clarity of the positional relationship.

Substrate part 50 includes a circuit that drives driving parts 40A and 40B. Substrate part 50 includes FPC (flexible printed board) 51, driver IC 52, inductors 53A and 53B, position detection sensors 54A and 54B and the like.

FPC 51 is a flexible substrate, and comprises a stack of a thin insulating layer such as a resin film and/or a metal layer such as a copper foil. Although not illustrated in the drawings, the metal layer is formed as a circuit of a signal line and/or a power source line, and is electrically connected to driving parts 40A and 40B, driver IC 52, inductors 53A and 53B, position detection sensors 54A and 54B and the like.

Driver IC 52 is an IC that controls a driving signal to drive driving parts 40A and 40B. For example, driver IC 52 outputs a driving signal based on the detection signal detected by position detection sensors 54A and 54B, and the output driving signal is output to driving parts 40A and 40B through inductors 53A and 53B.

Inductors 53A and 53B, each of which includes a coil, increase the voltage (input voltage) of the driving signal input from driver IC 52, and output it to driving parts 40A and respectively.

Position detection sensors 54A and 54B are magnetic sensors such as Hall elements, and outputs, as a detection signal, a signal corresponding to the positions in the Z direction of magnets 14A and 14B facing each other (the intensity of the magnetic field of magnets 14A and 14B), for example.

Note that although not illustrated in the drawings, FPC 51 is provided with a connection wiring that is electrically connected to driving parts 40A and 40B.

FPC 51 is a single long substrate to mount on FPC 51 the above-described driver IC 52, inductors 53A and 53B, and position detection sensors 54A and 54B. FPC 51 is disposed along the outer peripheral surface 24 of frame part 22 of housing part 20 so as to substantially encircle outer peripheral surface 24.

To dispose FPC 51 along outer peripheral surface 24, outer peripheral surface 24 at corner portions 22bA, 22bB and 22bC is formed in an arc-like shape in plan view. In this manner, FPC 51 can be disposed in an intimate contact with outer peripheral surface 24, including outer peripheral surface 24 at corner portions 22bA, 22bB and 22bC. In view of this, it is not necessary to increase the size of cover 3 disposed outside FPC 51, the reduction of the entire device can be achieved, and cost reduction can be achieved.

In addition, FPC 51 includes FPC main portion 51a, FPC constricted portions 51b and 51c, and FPC end portions 51d and 51e. FPC main portion 51a connects FPC constricted portion 51b and FPC end portion 51d on one end side and FPC constricted portion 51c and FPC end portion 51e on the other end side in the longitudinal direction, and driver IC 52 and position detection sensors 54A and 54B are mounted thereto.

FPC constricted portions 51b and 51c are portions with a reduced width in the direction orthogonal to the longitudinal direction, and are disposed between FPC main portion 51a and FPC end portion 51d, and between FPC main portion 51a and FPC end portion 51e, respectively. As illustrated in FIG. 9, FPC constricted portions 51b and 51c are portions formed to avoid the portion of housing part 20 where supporting parts 30B and are disposed. By providing such FPC constricted portions 51b and 51c, it is not necessary to increase the size of cover 3 disposed outside FPC 51, the reduction of the entire device can be achieved, and cost reduction can be achieved.

Inductors 53A and 53B are mounted at FPC end portions 51d and 51e, respectively, which are the both end portions in the longitudinal direction of FPC 51. As described above, inductors 53A and 53B include coils, and there are noise radiation and leakage flux from the coils. To ensure the distance from position detection sensors 54A and 54B that may be affected by the leakage flux and the noise radiation, inductors 53A and 53B are disposed at FPC end portions 51d and 51e. On the other hand, for position detection, position detection sensors 54A and 54B are disposed at positions close to driving parts 40A and 40B where the driving force acts.

In addition, optical element driving device body 4 includes cover members 60A and and metal layer 55 to suppress the leakage flux and the noise.

Cover members 60A and 60B are formed of a metal material that shields the leakage flux and the noise. Cover members 60A and 60B include lid part 61, flange part 63, an opening and the like.

Lid part 61 is a capped quadrangular cylindrical member with an opening. Flange part 63 extends at the outer periphery of the opening of lid part 61. More specifically, it extends along the surface of FPC end portions 51d and 51e at the outer periphery edge of lid part 61, which is the outer periphery part of opening.

Cover members 60A and 60B are configured to house inductors 53A and 53B mounted on FPC end portions 51d and 51e in the opening of lid part 61, and cover them with flange part 63 disposed on FPC end portions 51d and 51e.

In this manner, cover members 60A and 60B include not only lid part 61, but also flange part 63. Thus, the leakage flux and the noise radiated from inductors 53A and 53B to cover members 60A and 60B side can be shielded by lid part 61 and flange part 63 in a wide range. As a result, the magnetic flux and the noise leaked to the outside can be reduced in comparison with a cover member with no flange part.

Flange part 63 may be fixed to the surface of FPC end portions 51d and 51e with an adhesive or the like, for example. The contact area of the surfaces of FPC end portions 51d and 51e and flange part 63 are wider in comparison with the case where no flange part is provided, and thus cover members 60A and 60B can be reliably fixed to the surfaces of FPC end portions 51d and 51e.

At FPC end portion 51d, metal layer 55 is disposed to face inductor 53A attached to FPC end portion 51d. At FPC end portion 51d, metal layer 55 is provided at the surface on the side opposite to the surface where inductor 53A is mounted, for example. In plan view, metal layer 55 is formed in a solid pattern including at least the region where inductor 53A is disposed.

Since metal layer 55 is provided at FPC end portion 51d where inductor 53A is mounted in this manner, the leakage flux and the noise radiated from inductor 53A to FPC end portion 51d side can be shielded by metal layer 55. As a result, in comparison with an FPC with no metal layer 55 described above, the magnetic flux and the noise leaked to the outside through FPC 51 can be reduced.

Further, metal layer 55 is desirably formed to overlap flange part 63 as illustrated in FIG. 8. As a result, the gap between flange part 63 and metal layer 55 can be reduced. This is especially effective for the case where an FPC is used as a substrate.

Since the gap between flange part 63 and metal layer 55 is reduced in this manner, substantially the entire periphery of inductor 53A can be covered with cover member 60A and metal layer 55. In this manner, the leakage flux and the noise radiated from inductor 53A can be shielded by cover member 60A and metal layer 55. As a result, the magnetic flux and the noise leaked to the outside can be reduced.

Cover members 60A and 60B comprise of a metal material that reduces the leakage flux and the noise. For cover members 60A and 60B, a lamination structure in which at least layers comprising copper and nickel are stacked on a layer comprising iron such as SPCC (Steel Plate Cold Commercial), which is a ferromagnetic material, is used, for example. In this lamination structure, the layers are stacked in the order of the iron layer, the copper layer, and the nickel layer, and thus the rusting of the iron layer can be prevented.

The copper layer is stacked also for the purpose of offsetting the influence of the increase of the inductance due to the iron layer, and the noise shielding property can be improved by making the copper layer thicker than the nickel layer. As such, for cover members 60A and 60B, it is preferable to adopt a configuration in which, at least, the copper layer is thicker than the nickel layer in the lamination structure in which an iron layer and a copper layer and a nickel layer are stacked

In addition, in the circuit of FPC 51, metal layer 55 may use a ground layer or a power source layer for supplying the power source. In addition, metal layer 55 is not limited to a single layer, and may comprise a plurality of layers stacked through an insulating layer. For example, in the case where it comprises two layers stacked through an insulating layer, one layer and the other layer may be the above-described power source layer and ground layer.

In addition, in the case where the ground layer or the power source layer of the circuit of FPC 51 is not used as metal layer 55, metal layer 55 may comprise of a stack of a plurality of metal layers as with cover members 60A and 60B.

FIG. 10 is a diagram illustrating housing part 20 of optical element driving device body 4 illustrated in FIG. 3 as viewed from the inside, and is a diagram as viewed from direction D2 illustrated in FIG. 3 in the state where lens part 2 and holding part 10 are detached.

To achieve size reduction of the device, housing part 20 includes insertion parts 25A and 25B to which cover members 60A and 60B with the above-described configuration are inserted. As illustrated in FIG. 10, insertion parts 25A and 25B are provided to penetrate side wall part 22b of frame part 22, but it is possible to adopt a configuration, such as a recess, that does not penetrate side wall part 22b as long as cover members 60A and 60B can be inserted.

By inserting cover members 60A and 60B to such insertion parts 25A and 25B, the reduction of the entire device can be achieved, and cost reduction can be achieved.

In addition, in the case of the configuration illustrated in FIG. 10, for example, flange part 63 is fixed between housing part 20 and FPC 51 by fixing the part between housing part 20 and FPC end portion 51d with an adhesive or the like, and therefore flange part 63 need not be fixed on the surface of FPC end portions 51d and 51e. In this manner, the manufacturing process of optical element driving device body 4 can be simplified.

In addition, in the case where cover members 60A and 60B are inserted so as to fit to insertion parts 25A and 25B, cover members 60A and 60B serve also as a reinforcement of housing part 20 including insertion parts 25A and 25B, and thus deformation of housing part 20 and the like can be suppressed.

### Other Embodiments

The present invention is not limited to the above embodiments, but can be modified to the extent not to depart from the gist thereof.

For example, while first rail member 31 and second rail member 32 are provided at first groove part 15 and second groove part 26 in the present embodiment, it is possible to adopt a configuration in which they are not provided and first groove part 15 and second groove part 26 directly sandwich rolling member 33.

In addition, while supporting parts 30A, 30B and 30C have the same configuration in the present embodiment, a biasing member for providing a biasing force to rolling member 33 so as to press inward outer peripheral surface 13 of holding part 10 may be provided in one or more of the supporting parts. By providing such a biasing member, the tilting (tilt) of holding part 10 can be suppressed.

Here, frame part 22 of housing part 20 includes four corner portions 22bA, 22bB, 22bC and 22bD as illustrated in FIG. 3. In plan view, corner portions 22bA, 22bB, 22bC and 22bD include a space, and, since the supporting part including the biasing member requires a space, the supporting part is disposed at least one of corner portions 22bA, 22bB, 22bC and 22bD.

For example, in the example illustrated in FIG. 3, the above-mentioned biasing member is provided in supporting part 30A, and the supporting part 30A is disposed at corner portion 22bA. With this arrangement, space-saving of the device can be achieved, the reduction of the entire device can be achieved, and cost reduction can be achieved.

In addition, in one or more of the supporting parts, rolling member 33 may be configured to be displaceable in the circumferential direction in at least one of guide groove 31a of first rail member 31 and guide groove 32a of second rail member 32. While first groove part 15 and second groove part 26 are formed in V-shaped grooves as illustrated in FIG. 4, but at least one of them is formed in a U-shaped groove with a width greater than the diameter of rolling member 33, for example. In addition, while first rail member 31 and second rail member 32 are formed in V-shapes in cross-sectional view, at least one of them is formed in an I-shape in cross-sectional view, for example. With this configuration, at least one of the groove formed by first groove part 15 and first rail member 31 and the groove formed by second groove part 26 and second rail member 32 is formed in a U-shape.

With the U-shaped groove having the above-mentioned configuration, rolling member 33 is displaceable in the circumferential direction in the groove, thus allowing for relative displacement of outer peripheral surface 13 of holding part 10 and inner peripheral surface 23 of housing part 20 facing each other. With the supporting part having the above-mentioned configuration, even when holding part 10, housing part 20 and the like have an individual difference in dimensions and assembled states, such an individual difference can be accommodated.

Further, in the case where one or more supporting parts include the above-described biasing member, outer peripheral surface 13 of holding part 10 and inner peripheral surface 23 of housing part 20 relatively displace such that the force pressing rolling member 33 due to the biasing force of the biasing member and its reactive force are equivalent to each other in the supporting part including the above-mentioned U-shaped groove. As a result, the supporting position of holding part 10 is set with respect to a plurality of supporting parts including the supporting part including the above-mentioned U-shaped groove, and thus stable support with no backlash can be achieved.

In the example illustrated in FIG. 3, it suffices to adopt a configuration in which the above-mentioned U-shaped groove is provided at supporting part 30B disposed at the side between corner portion 22bB and corner portion 22bD and/or supporting part 30C disposed at the side between corner portion 22bC and corner portion 22bD.

In addition, in the example illustrated in FIG. 3, supporting parts 30B and 30C that do not require a space are disposed at the side in such a manner as to avoid corner portions 22bA, 22bB, 22bC and 22bD, and thus driving parts 40A and 40B that require a space can be disposed at corner portions 22bB and 22bC.

In addition, while two position detection sensors 54A and 54B are provided in the present embodiment, the number of the position detection sensor may be one. In this case, it is desirable to provide the detection sensor in the vicinity of the supporting part with a configuration in which the rolling member is sandwiched at the V-shaped groove (in other words, a supporting part that does not have the above-described biasing member and/or U-shaped groove). For example, in the case where in FIG. 3, supporting part 30A includes a biasing member, supporting part 30B includes a U-shaped groove, and supporting part 30C has a configuration in which the rolling member is sandwiched at the V-shaped groove, supporting part 30C serves as a reference (rotation center) of holding part 10 that can be relatively displaceable with respect to housing part 20. Therefore, it suffices that there is one position detection sensor 54B in the vicinity of supporting part 30C serving as such a reference.

In addition, the angle between supporting parts 30A, 30B and 30C is desirably 120°, but this angle may be changed as necessary. In the case where supporting parts 30A, 30B and 30C are disposed at an angle other than 120°, it is desirable to adopt the following configurations and arrangements.

For example, a biasing member is provided at supporting part 30A, and one of first groove part 15 and second groove part 26 is formed as a U-shaped groove in one of supporting part 30B and supporting part 30C. Then, in plan view, the pressing direction of the rolling member by the biasing member of supporting part 30A is set as the direction toward optical axis OA, and supporting part 30B and supporting part 30C are disposed at line-symmetric positions with respect to that direction. With such configurations and arrangements, the pressing force received from the supporting part 30A side is equalized in supporting part 30B and supporting part 30C, and thus holding part 10 can be stably supported.

In addition, the supporting part may be separately disposed at three or more portions in the circumferential direction of inner peripheral surface 23 (outer peripheral surface 13). In this case, it is desirable to dispose the supporting part at multiple of three portions, such as six and nine portions, with three-point support capable of stably supporting the object as a basic unit, so as to further support between the three-point supports.

In addition, while smartphone M is described as an example in the present embodiment, the present invention is applicable to a camera-mounted device including a camera module and an image processing part for processing the image information obtained by the camera module. The camera-mounted device includes an information device and a transport device. Examples of the information device include a camera-equipped mobile phone, a note-type personal computer, a tablet terminal, a mobile game machine, a web-camera, a camera-equipped in-vehicle device (such as a rear-view monitor device and a drive recorder device) and the like. In addition, the transport device includes an automobile and a drone, for example.

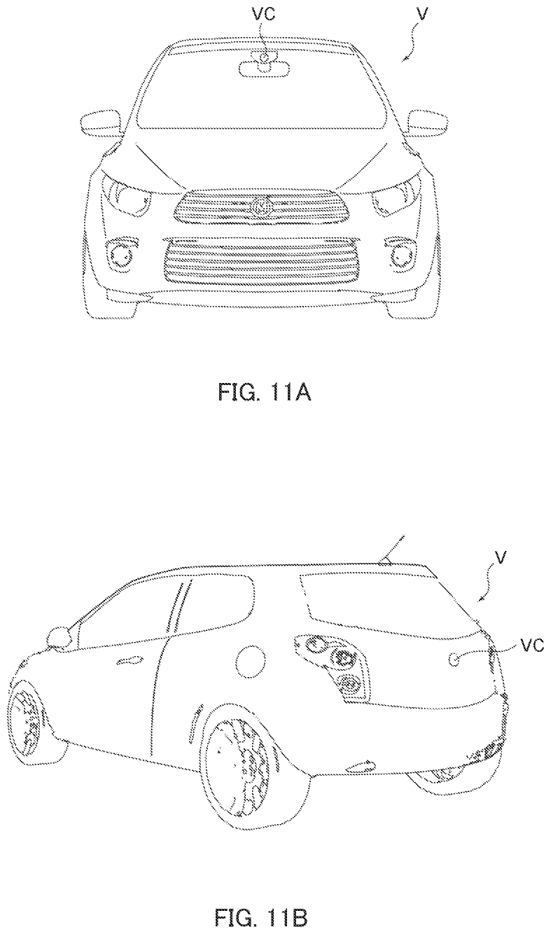

FIGS. 11A and 11B are diagrams illustrating automobile V serving as a camera-mounted device equipped with in-vehicle camera module VC (Vehicle Camera). FIG. 11A is a front view of automobile V, and FIG. 11B is a rear perspective view of automobile V. Automobile V is equipped with camera module A described in the present embodiment as in-vehicle camera module VC. As illustrated in FIGS. 11A and 11B, in-vehicle camera module VC is attached to the windshield to face forward, or attached to the rear gate to face rearward, for example. This in-vehicle camera module VC is used for a rear-view monitor, a drive recorder, a collision-avoidance control, an automated driving controlling and the like. In addition, while optical element driving device 1 that drives lens part 2 as the optical element is described in the present embodiment, the optical element to be driven may be an optical element other than the lens such as a mirror and a prism, or an optical element such as imaging element 502. In this case, opening 11 of holding part 10 may be changed in shape in accordance with the shape of the optical element to be attached, or may be omitted depending on the case.

In addition, while optical element driving device 1 has the AF function in the present embodiment, it may have not only the AF function, but also a function of moving lens part 2 in the Z direction such as a zoom function.

The above is a description of the embodiment of the present invention. The above description is an example of a preferred embodiment of the invention, and the scope of the invention is not limited thereto. In other words, the above description of the configuration of the device and the shape of each part is an example, and it is clear that various changes and additions to these examples are possible within the scope of the invention.

### INDUSTRIAL APPLICABILITY

The optical element driving device and the camera module according to the present invention are useful when they are mounted in camera-mounted devicees such as smartphones, mobile phones, digital cameras, note-type personal computers, tablet terminals, mobile game machines, in-vehicle cameras, and drones, for example.

### REFERENCE SIGNS LIST

1 Optical element driving device
2 Lens part
3 Cover
4 Optical element driving device body
5 Image-capturing part
10 Holding part
11 Opening
12 Frame part
13 Outer peripheral surface
14A, 14B Magnet
15 First groove part
16a, 16b Recess
17 Recess
18 Inclined part
19a, 19b Protrusion
20 Housing part
21 Housing opening
22 Frame part
22a Bottom part
22b Side wall part
22bA, 22bB, 22bC, 22bD Corner portion
23 Inner peripheral surface
24 Outer peripheral surface
25A, 25B Insertion part
26 Second groove part
27a, 27b Recess
29a, 29b Protrusion
30B, 30C Supporting part
31 First rail member
32 Second rail member
31a, 32a Guide groove
33 Rolling member
34 Retainer
34a Holding hole
40A, 40B Driving part
50 Substrate part
51 FPC
51a FPC main portion
51b, 51c FPC constricted portion
51d, 51e FPC end portion
52 Driver IC
53A, 53B Inductor
54A, 54B Position detection sensor
55 Metal layer
60A, 60B Cover member
61 Lid part
63 Flange part
301 Opening
501 Image sensor substrate
502 Imaging element
503 Control part

1. An optical element driving device configured to drive an optical element, the optical element driving device comprising:
a holding part configured to hold an optical element;
a housing part configured to house inside the holding part; and
a supporting part interposed between an outer peripheral surface of the holding part and an inner peripheral surface of the housing part, and including a plurality of rolling members configured to be held by a retainer in a rollable manner, the supporting part being configured to support the holding part with the plurality of rolling members such that the holding part is movable with respect to the housing part,
wherein at least one of the outer peripheral surface and the inner peripheral surface includes a first recess formed at a portion facing the retainer.

2. The optical element driving device according to claim 1,
wherein the supporting part supports the holding part such that the holding part is movable in an optical path direction of the optical element with respect to the housing part, and
wherein the first recess is disposed to face an end portion of the retainer in a direction orthogonal to the optical path direction.

3. The optical element driving device according to claim 2,
wherein the first recess extends along the end portion of the retainer extending in the optical path direction.

4. The optical element driving device according to claim 1,
wherein the supporting part supports the holding part such that the holding part is movable in an optical path direction of the optical element with respect to the housing part, and
wherein at least one of the outer peripheral surface and the inner peripheral surface includes a second recess formed adjacent to the first recess on a side opposite to a supporting part side in a direction orthogonal to the optical path direction.

5. The optical element driving device according to claim 1,
wherein the supporting part includes a groove configured to house the plurality of rolling members in at least one of the outer peripheral surface and the inner peripheral surface, and supports the holding part such that the holding part is movable in an optical path direction of the optical element with respect to the housing part, and
wherein the first recess and the groove are separated from each other with a protrusion interposed between the first recess and the groove in a direction orthogonal to the optical path direction.

6. A camera module comprising:
the optical element driving device according to claim 1;
a driving part configured to drive the holding part; and
an image capturing part configured to capture a subject image by using the optical element.

7. A camera-mounted device that is an information device or a transport device, the camera-mounted device comprising:
the camera module according to claim 6; and
an image processing part configured to process image information obtained by the camera module.
